(19) United States
(12) Patent Application Publication
(10) Pub. No.: US 2014/0294482 A1
(43) Pub. Date: Oct. 2, 2014

(54) Multi-Pocketed Sleeve System

(71) Applicant: Tavnir J. Carey, West Jordan, UT (US)

(72) Inventor: Tavnir J. Carey, West Jordan, UT (US)

(21) Appl. No.: 13/853,849

(22) Filed: Mar. 29, 2013

(51) Int. Cl. B42F 5/00

(52) U.S. Cl. CPC B42F 5/00
USPC 402/79

(57) ABSTRACT

A multi-pocketed sleeve system includes a first pocket sheet having a first set of pockets. A second pocket sheet includes a second set of pockets. A pocket is formed between the first and second pocket sheets by connecting at least a portion three edges of the first pocket sheet with at least a portion of adjacent three edges of the second pocket sheet. A binder edge is connected to the first and second pocket sheets and configured to be placed in a binder.

### CROSS-REFERENCE TO RELATED APPLICATIONS

Not applicable.

### BACKGROUND OF THE INVENTION

1. The Field of the Invention

A multi-pocketed sleeve system may include a series of four plastic sheets attached at various points to provide pockets where photographs or other memorabilia may be displayed. The four sheets may be grouped together in two pairs. The front pair of plastic sheets may be formed together in a sheet with multiple display pockets in a horizontal and vertical orientation, forming a matrix. Likewise, the back pair of sheets may also be formed together to form a sheet with a matrix of display pockets.

2. The Relevant Technology

There have been various concepts embracing designs for use in either organizing materials, or displaying various photographs or memorabilia. A typical use of this technology in scrapbooking is where an individual desires to display art work, photographs, poetry, thoughts, or other memorabilia. In order to do this in a pleasing, organized way and at the same time providing protection for the media being displayed, plastic sheeting has been utilized. There have been several embodiments trying in the best way possible to achieve this function.

The art in this area may be categorized into various areas. One area may be categorized as “Organizational Designs”, such as U.S. Pat. No. 4,312,393 issued Jan. 26, 1982 to Green for a “Coupon Organizer” provide plastic sheeting with pockets provided to allow coupons to be placed into the pockets in an organized manner so that they may be accessed easily upon demand. This is an organizing device with all the insertion pockets on only one side of the sheet. It is a two sheet folder, with the inside of the two sheets facing each other containing the pockets that are arranged with horizontal openings and spaced uniformly along the vertical height of the two facing sheets, forming uniform pocket sizes. The outside of the two facing sheets contains no pockets, but forms something that looks like a wallet with individual pockets in which the coupons could be placed.

The coupons placed in the pockets may be seen in part only. There is no attempt to have the entire coupon visible. The other coupons in pockets below a given pocket will hide a good portion of the coupon. All that is deemed necessary for this device is that the user be able to readily determine what is in the pocket. A full view is not deemed necessary, nor is it desirable, since the tight spacing allows more coupons to be displayed for retrieval.

These devices do not provide the needed benefits of a scrapbooking device as the subject invention. It provides only a limited view of the items to be displayed. There is no space allotted to add art work, text or other memorability in a creative method to that page.

Another area would be “Photo Displays in Forms Other Than for Displaying in Books” such as U.S. Pat. No. 6,796,426 B2 issued Sep. 28, 2004 to Fu et al. for “Sleeves and Album Pages for Flat Items.” This invention incorporates pockets with flexible plastic sheets on both sides of the device that are able to hold CD's or photograph or other memorabilia. In between the two pockets is a synthetic paper strip which is sealed between the two plastic pockets, forming one unit.

The difference is that in the multi-pocketed sleeve system the user is able to remove the central divider sleeve to add whatever information is desired, or to add multiple items. It is not sealed to the plastic and this central divider can be replaced at a later time at the discretion of the user. The other difference is that the sheets in the multi-pocketed sleeve are much larger, provide many more pockets and the orientation of the pockets are available in many additional combinations, including being able to combine one pocket into another. Another difference is that the referenced invention cannot be mounted into a book with other sheets added to it. It is meant for the storage of a CD with a maximum of only two pockets, or storage of a maximum of two CD's.

Another device that is a non-book type such as the “Multi-Purpose Organizer and Transporting Device”, Patent No. 2012/0125957 A1, dated May 24, 2012. This invention is more of an organizing device so that once items are placed into the individual pockets of the organizer, they are easily retrievable. They are not meant to be a display of the various items, but to separate the various items making them easy to locate. The pockets are only on one side of the organizer and when the pockets have items inserted and it is necessary to close the device, then it is simply necessary to fold the device in half so that the individual pockets are enclosed on the inside of the organizer. When the organizer is thusly closed, there are two handles that will therefore come together allowing the user to hold the two handles together, keeping the contents inside of the folder. To open the organizer, simple lay it on a surface and spread it open so that the two handles are the farthest apart from each other and the organizer is lying flat and open with the contents visible for removal.

The difference in this device is that it is an organizer with display pockets only on one side of the device. The normal view, unless opened is to have the contents enclosed in the device and not available for viewing.

A further area of art includes “Photo Displays to be installed in books” such as U.S. Pat. No. 2,421,503, issued Jun. 3, 1947 to Hermon for “Visible Care, Photograph, and Other Filing Sheets.” Here a central opaque sheet or transparent sheet that is bounded on both sides by transparent sheets which are cemented along the edges and in parallel, horizontal lines. Slits are provided to form the openings for the pockets where photographs or other memorabilia may be placed. The central opaque or transparent sheet is not removable since it is fastened to the front and back transparent sheets. Typically slits on one side of the opaque sheet are aligned with the slits on the opposite sides.

One difference between Hermon and the multi-pocketed sleeve system is that with the latter it is not necessary to remove the pages from the binder to see all the photographs or other memorabilia. Another difference is that the multi-pocketed sleeve system allows for the large divider sheet to be added or removed at any time and this divider sheet may be modified and displayed for any type of art work or photographic work or other memorabilia.

Photographs placed in the Hermon are all required to be oriented in one direction and pocket sizes are not variable to the user, only to the manufacturer during the manufacturing process. In contrast, the multi-pocketed sleeve system includes various pockets that may be provided with an open intercourse with an adjacent pocket, allowing a different size object to be inserted, up to twice the size of an item in a single pocket.

Another device is found in U.S. Pat. No. 4,965,948, issued on Oct. 30, 1990 to Ruebens for “Bi-Directional Album with Memo Area.” This design embodies individual pages that allow photos to be inserted into a transparent sheet and then to one side a lined paper is provided as an integral part of the page that allows the user to include memos concerning the photos that have been incorporated on that page. The binder is a multi-ring binder that the number of pages are fixed by the manufacturer and the necessity would be evident that multiple books would be required if space was not adequate for a single book. Pages cannot be added and deleted.

Another problem is that there are only three spaces, or pockets allowed for photographs. Additionally the photographs are only restricted from movement in a single corner on the upper two pockets. This limits the use of the pockets to a particular size photograph or memorabilia. It is therefore conceivable that the photos, being dislodged, may not be kept in a strictly horizontal format. If smaller format photos were to be used, they would even be less likely to be held in place with only as few as one corner supporting the photo. There is a memo section where the user may write notes concerning the photos, but they are meant to be handwritten. With the proliferation of computers, it is conceivable that this is no longer a desirable feature (hand written memos) and this activity would be supplemented with computer generated notes that are placed beside, or on top of the photo.

A further difference is that the embodiments of the multi-pocketed sleeve include more photographs or other memorability on a single page. This design allows complete capture of the photo in the individual compartments. As many multi-pocketed sleeves may be added as required, by means of a three ring binder to hold these large format scrapbooking pages Like in Ruebens there are photo slots on both sides of the page, but unlike Ruebens, the multi-pocketed sleeve system allows a display page to be sandwiched between the two sides of the transparent sheets. This allows the display page to be seen at all gaps in the photo display area, as opposed to seeing blank spaces, or worse, the back side of the photographs on the reverse side of the photo display page.

Another advantage of the multi-pocketed sleeve system is that the photographs or other memorabilia is captured for the most part on typically three interfaces with a full heat seal. The subject invention discussed above has only spot heat welds that may allow the inserted item to fall down into the next item and not be captured adequately. The idea of the spot welds was to allow photographs to be placed in the book either horizontal or vertical, but may cause an unwanted effect of allowing the photograph to slip out of its desired position.

With the advent of the computer and computer software, one is allowed the flexibility to be able to easily make changes to a sheet by adding photos and print and any form. With the subject invention the user is required to hand write notes to the side of the inserted photos in the lined spaces provided to the side of the photo pockets. If the notes are in ink, then they become permanent. If they are in pencil they disappear over time and smudge. Note taking is further hampered in that the pages cannot be removed and replaced. The book is fixed in spacing and number of pages by a permanent multi-ring binder.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In at least one example, a multi-pocketed sleeve system includes a first pocket sheet having a first set of pockets. A second pocket sheet includes a second set of pockets. A pocket is formed between the first and second pocket sheets by connecting at least a portion three edges of the first pocket sheet with at least a portion of adjacent three edges of the second pocket sheet. A binder edge is connected to the first and second pocket sheets and configured to be placed in a binder.

In another example, a multi-pocketed sleeve system includes a first pocket sheet having a first sheet and a second sheet. The first and second sheets are formed together in an arrangement to define a first set of pockets. A second pocket sheet includes a third sheet and a fourth sheet. The third and fourth sheets are formed together in an arrangement to define a second set of pockets. A pocket is formed between the first and second pocket sheets by connecting at least a portion three edges of the first pocket sheet with at least a portion of adjacent three edges of the second pocket sheet. A binder edge is connected to the first and second pocket sheets and configured to be placed in a binder.

These and other objects and features of the present invention will become more fully apparent from the following description and appended claims, or may be learned by the practice of the invention as set forth hereinafter.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is an isometric view of a first orientation of the multi-pocketed sleeve system showing a divider being inserted into a center opening.

FIG. 2 is an isometric view of a second orientation of the multi-pocketed sleeve system.

FIG. 3 is a front view of the multi-pocketed sleeve system illustrating a photograph or other memorabilia being inserted into a pocket.

FIG. 4 is a back view of the multi-pocketed sleeve system illustrating a photograph or other memorabilia being inserted into a pocket.

FIG. 5 is disassembled, open view of the multi-pocketed sleeve system.

FIG. 6 is an isometric view of the multi-pocketed sleeve system being assembled by rotating and attaching the sides together.

FIG. 7 is an isometric view of the multi-pocketed sleeve system in a final assembly arrangement.

### DETAILED DESCRIPTION OF THE VARIOUS EMBODIMENTS

The various embodiments of the multi-pocketed sleeve system include a series of four plastic sheets attached at various points to provide pockets where photographs or other memorabilia may be displayed. The four sheets are made up of two pairs. The front pair of plastic sheets may be together to form a sheet with multiple display pockets in a horizontal and vertical orientation, forming a matrix. Likewise, the back pair of sheets may also be heat sealed together to form a sheet with a matrix of display pockets.

The pairs of plastic sheets are heat sealed together horizontally and vertically with a desired spacing to allow photographs or other memorabilia to be placed in rows inside the pockets formed by this heat welding. The front sheet of the front pair of sheets may have pocket openings at the center of the front sheet. The photographs or other materials may therefore be inserted from the center of the front plastic sheet and slid into the various pockets, either to the left or right of the center of the front sheet. If the pocket openings are provided in the first sheet then the second sheet, or back sheet of the first pair will have no openings. One or more pockets may be left without a horizontal heat weld which will allow open access to an adjacent pocket. Therefore a taller object may be utilized that extends out of one pocket and vertically upward into another in this location.

The back pair of plastic sheets are likewise heat sealed together to form pockets. The configuration of the pockets may be set up so that all entrances to the pockets on the back pair of plastic display sheets are on the interior of the multi-pocketed sleeve system (between the two sets of pairs) as opposed to facing rearward on the back pair of plastic display sheets. If the pockets are facing forward (openings in the third sheet, as opposed to the back, or fourth sheet) then display items or memorabilia will be inserted by reaching into the center between the two pairs of plastic sheets and inserting these items into the third sheet pockets. If this configuration is chosen, no access to the back sheet (fourth sheet) of the multi-pocketed sleeve system will be provided. The displayed items therefore are encapsulated and protected, not to be disturbed since they are accessible by reaching into the center of the multi-pocketed sleeve system.

If the pocket openings are configured in the third sheet as stated above, slots to access these pockets will be provided in the top of each pocket. Thusly easier access is provided for the user to be able to reach into the center of the multi-pocketed sleeve system and insert and remove memorabilia from these pockets. This is because reaching into a pocket from a vertical downward direction is easier than accessing the pocket from the side in this confined space.

All four sheets are all heat sealed together on three sides—the two side edges and the bottom edge so that they act as one sheet. On the left edge a broader vertical conjoined band is provided so that holes may be punched which will allow the four page assembly to be installed into a binder made for this enlarged multi-pocketed sleeve system. The front pair of plastic sheets is sealed at the top if this pair is set up for side entrance pockets. The back pair of plastic sheets are not sealed at the top, but left open if the media is inserted into top accessible pockets.

A feature of this design is that a large divider sheet incorporating a graphic design or memorabilia may then be placed between the first and second pair of plastic sheets. This center space of the multi-pocketed sleeve system between the two pairs is left open with no top seal so that this entire center section is available for inserting this divider sheet of the user's choice.

Because all four sheets of the multi-pocketed sleeve system are fabricated from transparent plastic, this centralized media divider sheet would be seen from both the front and back of the multi-pocketed sleeve system wherever there was an opening between the photographs or memorabilia that have been included in the matrix of pockets in the two pairs of sheets. In addition, since the four sheets are heat sealed at the two side edges and the bottom edge, this central access space is encapsulating and securing this large center divider sheet.

It is possible that the user may want to leave some of the pockets empty so that visual access is provided to this large center divider sheet. This full size media page may be a solid color, a pattern, an art work, computer generated work, or handwriting, or whatever the user would like to create as the general theme for this grouping of media objects that are displayed in the pockets of the multi-pocketed sleeve system. The multi-pocketed sleeve system may then be combined with other similar sleeves in a book that may be used by scrap bookers or other hobbyists.

As described, the pockets may be set up to be accessible from the front of the first pair of sheets (pockets cut into the first sheet) and from the front of the second pair of sheets (pocket cut into the third sheet). If desired, however, it is also possible to have these open pockets in any combination of the four sheets. For example they may be set up so that access to the pockets is accessible from the front (first sheet) for the front pair of plastic display sheets and from the back on the back pair of sheets (or the fourth sheet). This will make the accessibility slightly easier, but also encapsulate the displayed items as well to protect them.

Likewise a scenario could be selected where all the openings of the pockets are accessed from the center section of the multi-pocketed sleeve system (access cut in the second and third sheet). This would afford the least accessibility for the media in the pockets, but conversely would provide the most security of the media displayed since there is no access to the media from either the front sheet (first sheet) or the back sheet (fourth sheet).

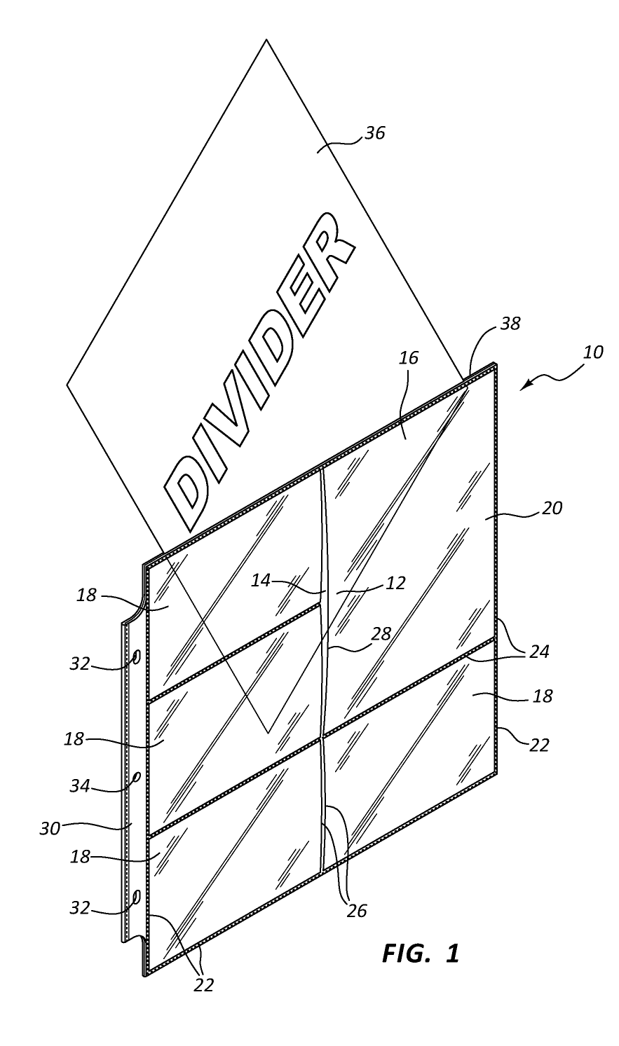

FIG. 1 is an isometric view of the multi-pocketed sleeve system 10, depicting a first orientation of the components that comprise this system. This multi-pocketed sleeve system 10 utilizes four plastic transparent sheets that are bonded together with heat sealed seams to form the final system. As shown in this view one can observe the front side of the multi-pocketed sleeve system that comprises the first two transparent plastic sheets 12, 14 that together make the front transparent pocket sheet 16. The two transparent plastic sheets are formed into a set of display pockets 18 and a large pocket 20 by heat sealed seams 22 being placed to create rows and columns. This process forms borders for the pockets, sealing three edges 24 of the pockets together to form an encapsulated area for photographs, art work, or other memorabilia.

The heat sealed seams 22, being both horizontal and vertical create the display pockets 18, 20, and at the same time weld the first two front sheets 12, 14 together. When sealing the display pockets 18, 20 together, the heat sealed seams 22 create a seal around the entire outside boundary (top and bottom edge and left and right edge) of the front transparent pocket sheet 16. When forming the display pockets 18, 20 as mentioned with the heat seals, a set of pockets are formed that are enclosed on three sides 24. One side of each of the pockets is left open forming openings 26, 28 without sealing occurring, so that the photographs, art work, or other memorabilia is permitted to be inserted into the pockets 18, 20.

In the display pockets 18, 20 of the front transparent pocket sheet 16, an orientation of pocket openings 26, 28 may be facing the center of the front transparent pocket sheet 16. These openings are in the front side of the first two transparent sheets that make up the front transparent pocket sheet 16. The second sheet 14 of the front transparent pocket sheet 16 has no cutouts in it and forms a solid back side. The display pockets 18 to the left are oriented to open towards the center or to the right. The large display pocket 20 and the display pocket 18 on the right are oriented to open towards the center or the left.

The pocket openings 26, 28 on the front pocket sheet 16 may face the center of the front pocket sheet 16, but could alternately be positioned to the top of each of the display pockets 18, 20. The manufacturing process could also provide for a combination of these pocket opening orientations, some pockets may open to the center of the front pocket sheet while others may open from the top.

The pocket openings 26, 28 also could have another placement option, among perhaps other combinations. They may be placed in the back side of the front pocket sheet 16. For instance, the display pockets may be oriented to open from the inside by arranging the openings in the second sheet 14 of the front pocket sheet 16.

Another option, as shown in the large display pocket 20, would be to eliminate the horizontal bottom heat sealed seam 22 in one or more of the upper display pockets 18 and allow it to communicate with a lower display pocket, or create a larger pocket. The large display pocket 20 may be twice as big as the other display pockets 18.

On the left edge of the front pocket sheet 16 is a heat sealed binder edge 30 that is sized to accommodate standard three hole punch binder slots 32 and hole 34. The binder edge 30 allows the user to place the multi-pocketed sleeve system 10 into a binder, such as a scrapbook that is specially designed for scrapbooking with dividers or other storage means as needed.

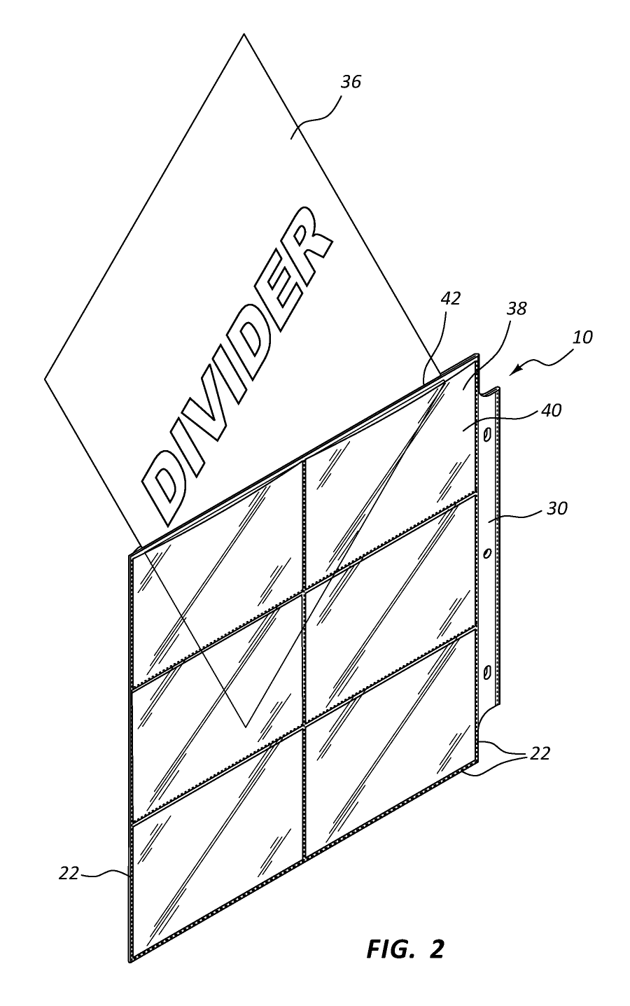

A divider 36 may be placed in a pocket formed between the front pocket sheet 16 and a back pocket sheet 38. The back pocket sheet 38 is illustrated in FIG. 2. The front pocket sheet 16 is attached to the back pocket sheet 38 at three edges (top, left and right sides) with the heat sealed seam 22 to create a center pocket for the divider 36. The front and back pocket sheets 16, 38 are sealed together completely at the two side edges and the bottom edge, an opening is therefore provided in the top of the multi-pocketed sleeve system formed by these two sheets being place one on top of the other. This leaves an opening in the top between the transparent pocket sheets 16, 38.

Because there is a large open pocket between the front and back pocket sheets 16, 38, a space may be allotted for insertion of additional photographs, art work or other memorabilia. A divider 36 may also be inserted in the opening. The divider 36 may be a customized by the user to present a theme, style or pattern that ties into the pieces placed in the display pockets of the front and back pocket sheets 16, 38. The divider 36 may be changed at any time, or it can be duplicated and placed in other multi-pocketed sleeve systems 10.

The divider 36 is designed at the discretion of the user. It may be a printed sheet with the same pattern on both sides, or a sheet that displays art work, notes, a graphic design, additional photography or other memorabilia. It may be a computer generated piece of art, drawing or computer generated photographs. This divider 36 is a feature that allows the user to create a unique piece for the scrapbook. Whatever is placed on this divider 36, if desired, may be seen from the front pocket sheet 16 or from the back pocket sheet 38. Some of the divider 36 may be blocked by the pieces the user inserts into the display pockets in the front and back pocket sheets 16, 38. At the option of the user, some of the pockets may be left empty so the divider is completely visible in a specific area.

FIG. 2 is an isometric view of the multi-pocketed sleeve system illustrated from a second orientation, or the flip side of FIG. 1. FIG. 2 shows the back transparent pocket sheet 38 with the front pocket sheet 16 in the back.

As shown in this view, one can observe the back side of the multi-pocketed sleeve system 10 that includes the third and fourth transparent plastic sheets 40, 42 that together make up the back pocket sheet 38. The two transparent plastic sheets are formed into a matrix of display pockets 44 with openings 46 by heat welding vertical and horizontal borders for the pockets sealing the edges of the pockets together to form a complete encapsulated area for media 50, such as photographs, art work, or other memorabilia at the discretion of the user.

The heat sealed seams 48, being both horizontal and vertical create the display pockets 44 and at the same time weld the last two of a total of four transparent sheets. This comprises the back transparent pocket sheet 38. When sealing the last two transparent sheets together, the display pockets 44 are formed. When the sealing is done for the pockets, the heat sealed seams 22 create a seal around three sides of the outside boundary of the last two transparent sheets forming the back transparent pocket sheet. The bottom edge and left and right edge of the back transparent pocket sheet 38 are therefore created with these heat sealed seams 22. When forming the display pockets 44 as mentioned with, for example, the heat seals 48, a matrix of pockets are formed that are completely enclosed on three sides. One side of each of the pockets is left open without sealing occurring, so that the photographs, art work, or other memorabilia is permitted to be inserted into said pockets.

In the case of the display pockets 44 on the back transparent pocket sheet 38, an orientation of pocket openings 46 in the display pockets 44 would typically be facing upward at the top of each of the pockets. Furthermore, this option proposes the openings being on the inside center of the multi-pocketed sleeve system 10, between the front and back transparent pocket sheets 16, 38. In other words, the openings 46 would be in the top of each of the pockets 44 and in the third of four total transparent sheets. This allows easy access to the openings when the user reaches into the center space where the divider 36 is inserted.

The pocket openings 46 on the back transparent pocket sheet 38 would not be exclusively required to be in the tops of each of the pockets, but as in the pockets in the front transparent pocket sheet 42, they could alternately be placed in other configurations. The openings could be facing sideways toward the center as was the base case for the front transparent pocket sheet.

As another alternate the display pockets 44 could be placed, instead of in the third transparent display sheet 40, the openings could be placed in the fourth sheet 42 or on the backside, or outside surface of the multi-pocketed sleeve system 10.

Not displayed in this view is the front transparent pocket sheet 16. It was better shown and discussed in detail in FIG. 1 above. Since the front and back transparent pocket sheets 40, 42 are sealed together completely at the two side edges and the bottom edge, an entrance is therefore provided in the center-top of the multi-pocketed sleeve system formed by these two sheets being place one on top of the other. This leaves an opening in the top between the transparent pocket sheets 16 and 38 as was discussed with respect to FIG. 1.

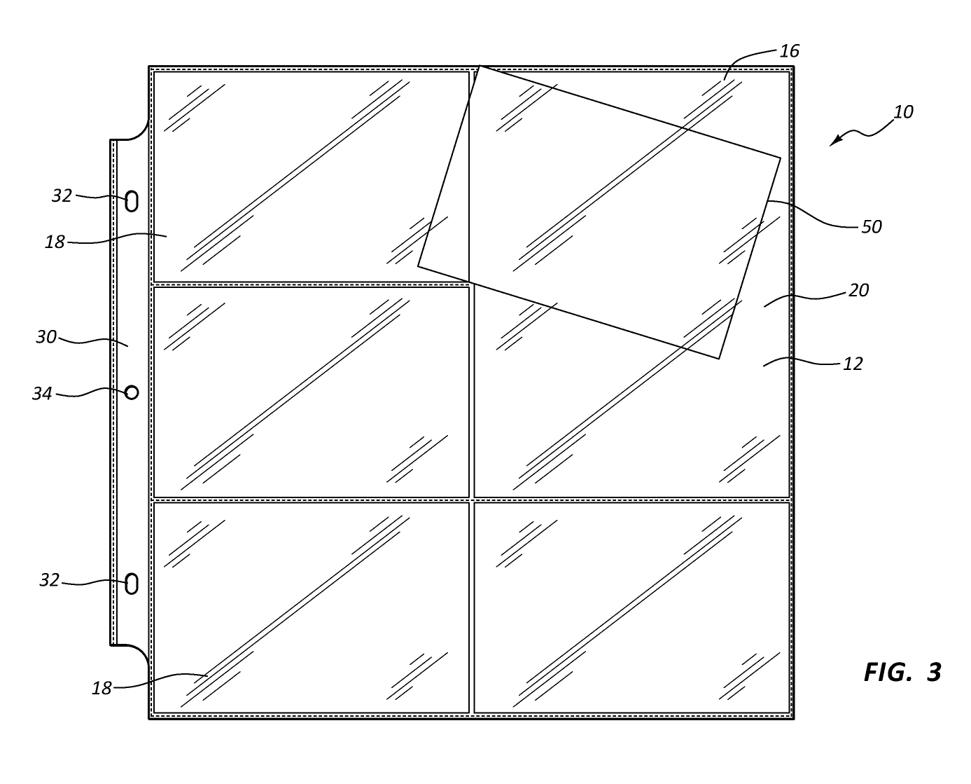

FIG. 3 is the front view of the multi-pocketed sleeve system 10. Because this is a front view, the front transparent pocket sheet 16 is displayed. This view shows how the display pockets 18 are oriented and how display items 50 such as photographs, art work or other memorabilia may be displayed. This view depicts the display item 50 being inserted into the pocket opening 18. As mentioned earlier, the pocket 18 is formed with heat sealed seams 24 on three sides.

The pocket openings 26, 28 on the front transparent pocket sheet 16 would not be exclusively required to be facing the center of the front transparent pocket sheet as shown, but could alternately be positioned to the top of each of the display pockets 18, 20 or a combination of these pocket opening orientations, some opening to the center of the front transparent pocket sheet and some opening in the top of the display pockets 18, 20.

The pocket openings 26, 28 also could have another placement option, among perhaps other combinations. They may be placed in the back side of the front transparent pocket sheet 16. This is the second sheet of the pair of transparent sheets comprising the front transparent pocket sheet 16.

Another option, not shown would be to eliminate the horizontal bottom heat sealed seam 24 in one or more of the upper display pockets 18 and allow it to communicate with the display pocket 18 immediately below it, creating a large pocket 20, for instance. This would create a pocket twice the size of the other display pockets.

To the left of the front transparent pocket sheet 16 is provided a heat sealed binder edge 30 that is wide enough and long enough to allow three hole punches to be provided. With the slots 32 and hole punch 34 in place, the multi-pocketed sleeve system 10 can be installed into a scrapbook that is specially designed for scrapbooking or other storage means as needed.

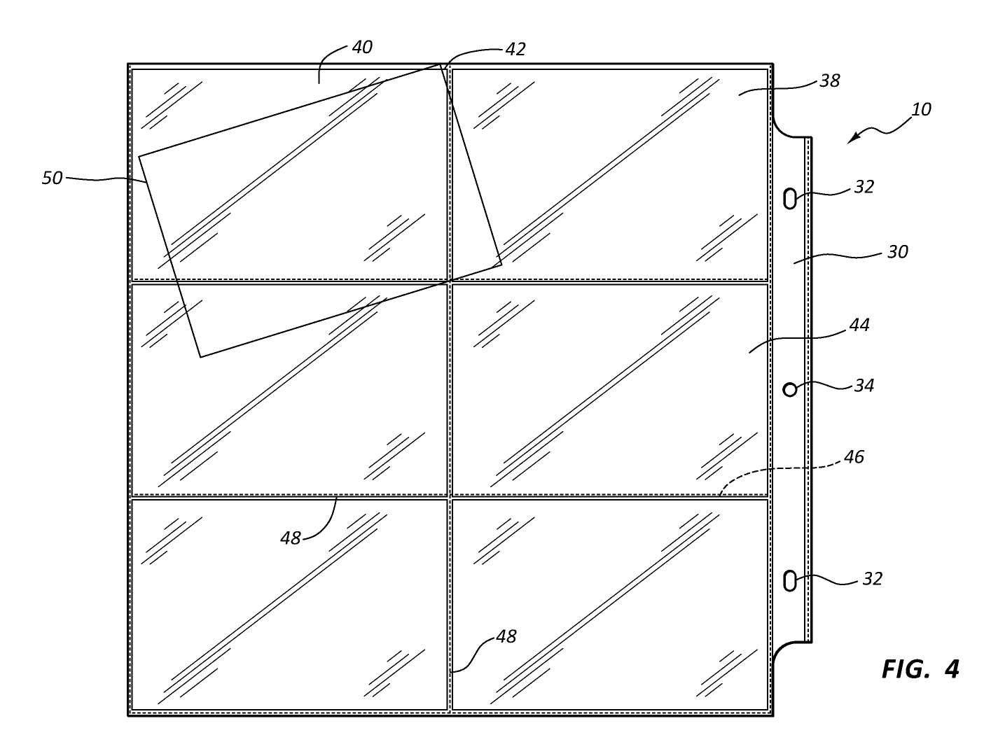

FIG. 4 is the back view of the multi-pocketed sleeve system 10. Because this is a back view, the back transparent pocket sheet 38 is displayed. This view shows how the display pockets 44 are oriented and how display items 50 such as photographs, art work or other memorabilia may be displayed and inserted into the display pockets 44. This view depicts the display item 50 being inserted into the pocket opening 46. The pocket openings, in this case are positioned on the inside, or center space where the divider 36 is inserted (see FIG. 2). The user has access to these openings by reaching inside the center space between the back transparent pocket sheet and the front transparent pocket sheet. As mentioned earlier, the display pockets 44 are formed with heat sealed seams 48 on three sides of each pocket 44.

The pocket openings 46 on the back transparent pocket sheet 38 would not be required to be exclusively located at the top of each transparent pocket sheet as shown. This is a desirable location for the pocket openings 46 to be placed if the access to the center area of the multi-pocketed sleeve system is required to access these openings. The center access is beneficial in that it totally encapsulates all the pocket openings 46 within the center area of the multi-pocketed sleeve system 10.

The pocket openings 46 could alternately be positioned in different locations if the pocket openings were positioned on the outside surface on the back of the multi-pocketed sleeve system 10. If this were the case the pocket openings 46 could be placed at the center of the back transparent pocket sheet 38, or a combination of these pocket opening orientations; some opening to the center of the back transparent pocket sheet 38 and some opening in the top of the display pockets 44.

Another option, not shown would be to eliminate the horizontal bottom heat sealed seam 48 in one or more of the upper display pockets 44 and allow it to communicate with the display pocket 44 immediately below it. This would create a pocket twice the size of the other display pockets.

To the right of the back transparent pocket sheet 38 is provided a heat sealed binder edge 30 that is wide enough and long enough to allow three hole punches to be provided. With the slots 32 and hole 34 in place, the multi-pocketed sleeve system 10 can now be installed into a scrapbook that is specially designed for scrapbooking or other storage means as needed.

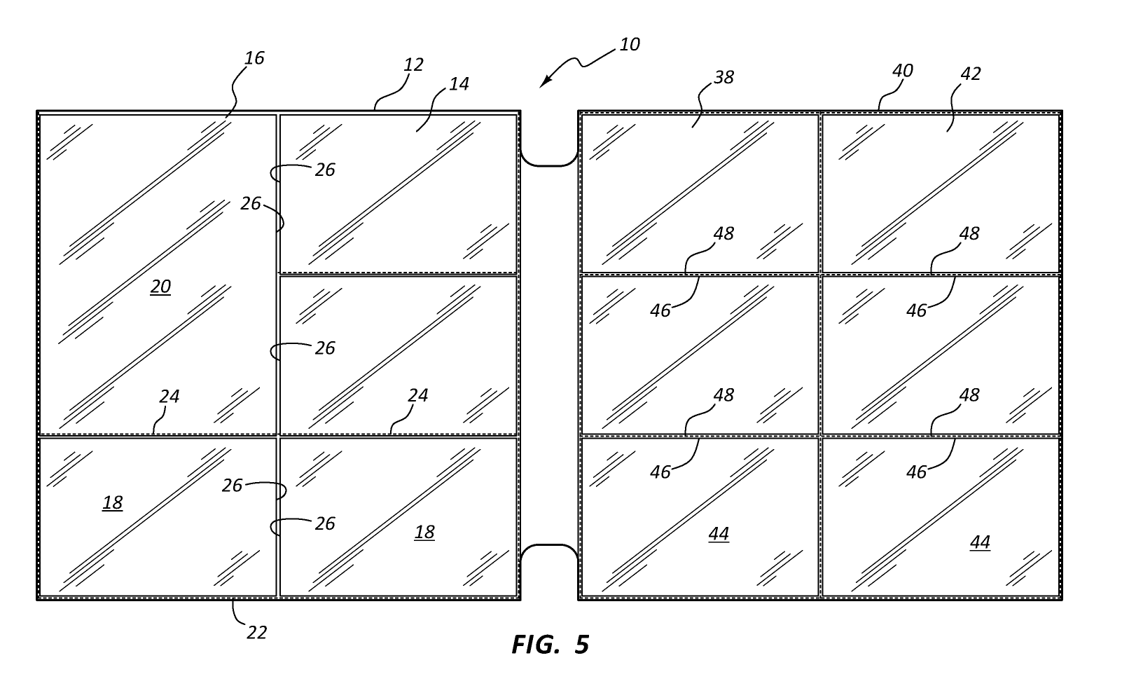

FIG. 5 is a fold out view that displays the multi-pocketed sleeve system 10 in the unassembled state, prior to heat sealing the front and back transparent pocket sheets 16, 38 together forming the multi-pocketed sleeve system 10.

This figure depicts the two pairs of sheets and how they, together form the front transparent pocket sheet 16 and the back transparent pocket sheet 38. The front transparent pocket sheet 16 is made up of a pair of plastic transparent sheets 12, 14 that are heat sealed together by forming a matrix of display pockets 18. The openings for those display pockets, in this case, are shown being located at the center of the front transparent pocket sheet 16.

The back transparent pocket sheet 38 is also made up of a pair of plastic transparent sheets 40, 42 that are heat sealed together with heat sealed seams 48 by forming a matrix of display pockets 44. The openings for those display pockets, in this case are shown being located at the top of each of the display pockets 44. Note that these pocket openings 46 are on the back side of the back transparent pocket sheet in this view. This would then place the openings in the center area between the front and the back transparent pocket sheets 16, 38 of the multi-pocketed sleeve system 10.

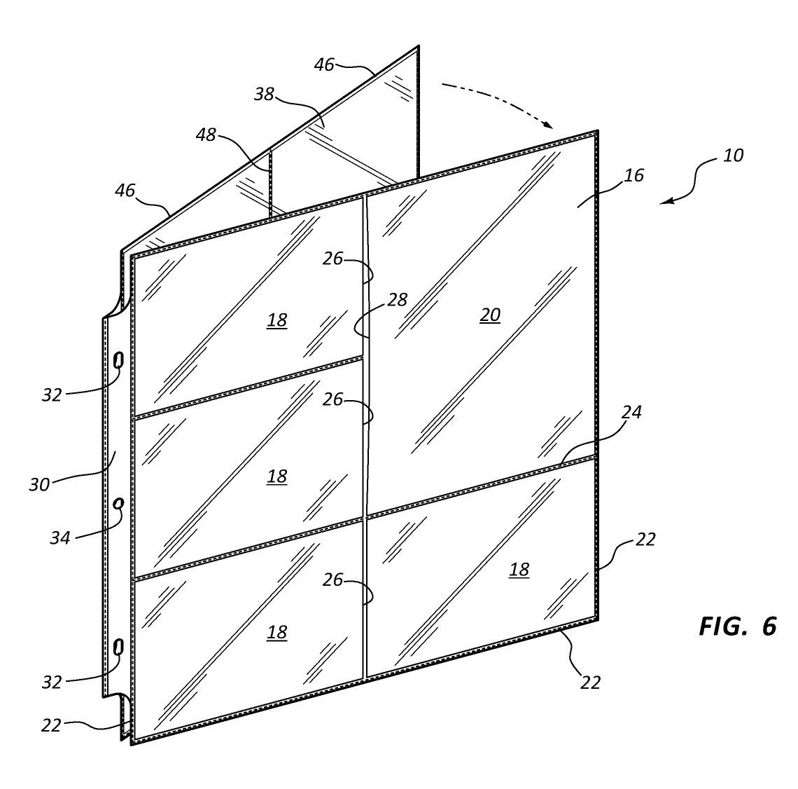

FIG. 6 is a three dimensional view of the multi-pocketed sleeve system 10 as the front transparent sheet 16 is being folded into the back transparent sheet 38 forming the completed assembly. More clearly seen here are the relative locations of the pocket openings 26, 28 in relation to the entire assembly. Note how the user may have access to the pocket openings 46 on the back transparent pocket sheet 38 by reaching into the center area of the multi-pocketed sleeve system 10. Also it may be observed that the heat sealed binder edge 16 is integrally connected to the front and back transparent pocket sheets.

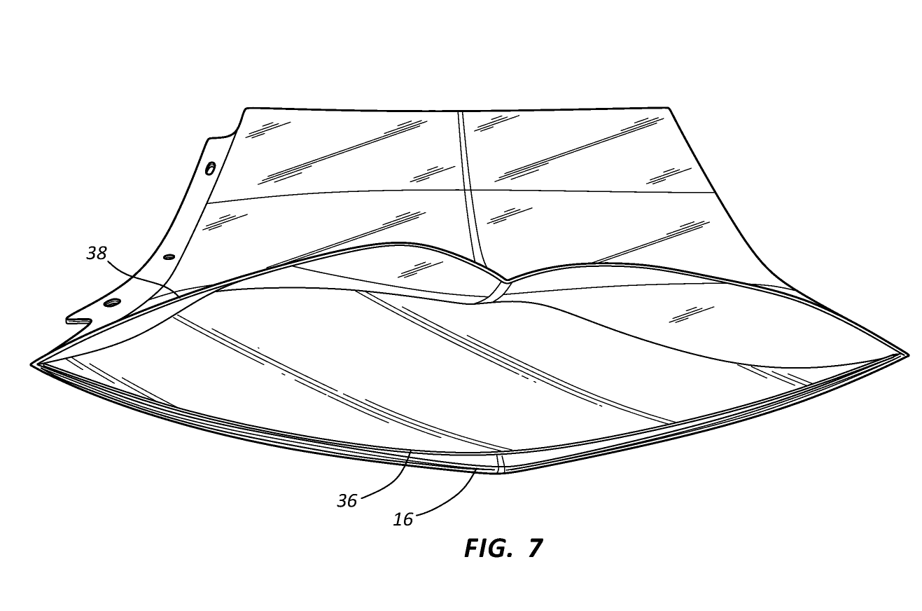

FIG. 7 is a three dimensional view showing the fully assembled and heat sealed assembly of the multi-pocketed sleeve system 10. Here is shown the series of four transparent sheets and how the front pair makes up the front transparent pocket sheets 16 and the back pair make up the back transparent pocket sheets 38. The front and the back transparent pocket sheets are heat sealed with seams 22 on the two sides and along the bottom forming a large central opening in which the divider 36 can be inserted.

In summary, the multi-pocketed sleeve system 10 may provide pockets for a wide variety of sizes and ranges of photographs and other memorabilia. Smaller size items may be used in smaller pockets since there is a full weld on three corners of each pocket. Some pockets may be expandable to twice the size of the other pockets.

A user may place a central divider sleeve in between the pocket sheet, which may be removed or modified when desired. The centrally located divider sleeve may include any number of media type, from hand art work, to handwriting, to computer generated work, or even a sewn textile. This divider will be visible through the back transparent sheets or the front transparent pocket sheets when there are no media to restrict the view.

Multi-pocketed sleeve system pages may be easily added or deleted to the scrapbooking book with the enlarged three-ring binder. The entire photograph or other media that are placed in the pocket will be visible as long as it stays within the boundary of the pocket or pockets. The pockets may hold items, such as photographs, memorabilia, media and even the central divider sheet, require no adhesive or special consideration for attaching them to the multi-pocketed sleeve system since they all will be captured in the pockets.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A multi-pocketed sleeve system, comprising:
a first pocket sheet having a first set of pockets;
a second pocket sheet having a second set of pockets;
a pocket formed between the first and second pocket sheets, the pocket being formed by connecting at least a portion three edges of the first pocket sheet with at least a portion of adjacent three edges of the second pocket sheet; and
a binder edge connected to the first and second pocket sheets and configured to be placed in a binder.

2. The multi-pocketed sleeve system of claim 1, wherein the first set of pockets includes at least two columns of pockets and the pockets open towards the center, between the columns of pockets.

3. The multi-pocketed sleeve system of claim 1, wherein at least two of the pockets in the first set of pockets have openings that face each other and open towards the center of the first pocket sheet.

4. The multi-pocketed sleeve system of claim 3, wherein at least one of the pockets in the second set of pockets has an opening that opens towards and top edge of the second pocket sheet.

5. The multi-pocketed sleeve system of claim 1, further including a divider placed between the pocket formed between the first and second pocket sheets, the divider being at least partially visible through at least one of the first and second pocket sheets.

6. The multi-pocketed sleeve system of claim 1, wherein the first pocket sheet includes a first sheet and a second sheet, the first sheet being connected to the second sheet at edges of the first set of pockets.

7. The multi-pocketed sleeve system of claim 6, wherein the second pocket sheet includes a third sheet and a fourth sheet, the third sheet being connected to the fourth sheet at edges of the first set of pockets.

8. The multi-pocketed sleeve system of claim 7, wherein the first, second, third and fourth sheets are connected together along three edges to form the pocket between the first and second pocket sheets.

9. The multi-pocketed sleeve system of claim 6, wherein the first sheet of the first pocket sheet includes openings for the first set of pockets.

10. The multi-pocketed sleeve system of claim 7, wherein the third sheet of the second pocket sheet includes openings for the second set of pockets.

11. The multi-pocketed sleeve system of claim 1, wherein at least one pocket of the first set of pockets includes a pocket that is larger than the other pockets in the first set of pockets.

12. A multi-pocketed sleeve system, comprising:
a first pocket sheet having a first sheet and a second sheet, the first and second sheets being formed together in an arrangement to define a first set of pockets;
a second pocket sheet having a third sheet and a fourth sheet, the third and fourth sheets being formed together in an arrangement to define a second set of pockets;
a pocket formed between the first and second pocket sheets, the pocket being formed by connecting at least a portion three edges of the first pocket sheet with at least a portion of adjacent three edges of the second pocket sheet; and
a binder edge connected to the first and second pocket sheets and configured to be placed in a binder.

13. The multi-pocketed sleeve system of claim 12, wherein the first set of pockets includes at least two columns of pockets, the pockets of each column being configured to open towards the margin between the columns.

14. The multi-pocketed sleeve system of claim 12, wherein at least one of the pockets in the second set of pockets has an opening that opens towards and top edge of the second pocket sheet.

15. The multi-pocketed sleeve system of claim 12, further including a divider placed between the pocket formed between the first and second pocket sheets, the divider being at least partially visible through at least one of the first and second pocket sheets.

16. The multi-pocketed sleeve system of claim 12, wherein the first, second, third and fourth sheets are connected together along three edges to form the pocket between the first and second pocket sheets.

17. The multi-pocketed sleeve system of claim 12, wherein the first sheet of the first pocket sheet includes openings for the first set of pockets.

18. The multi-pocketed sleeve system of claim 12, wherein the third sheet of the second pocket sheet includes openings for the second set of pockets.

19. The multi-pocketed sleeve system of claim 12, wherein at least one pocket of the first set of pockets includes a pocket that is larger than the other pockets in the first set of pockets.
